(19) United States
(12) Patent Application Publication
(10) Pub. No.: US 2020/0223468 A1
(43) Pub. Date: Jul. 16, 2020

(54) TRAVELING DEVICE AND CARRIAGE

(71) Applicant: SHARP KABUSHIKI KAISHA, Sakai City (JP)

(72) Inventor: SHINICHI AZUMI, Sakai City, Osaka (JP)

(21) Appl. No.: 16/734,849

(22) Filed: Jan. 6, 2020

(30) Foreign Application Priority Data
Jan. 10, 2019 (JP) 2019-002963

(51) Int. Cl. B62B 5/00; B61G 1/32

(52) U.S. Cl. CPC B62B 5/0079; B62B 2207/00; B61G 1/32

(57) ABSTRACT

Provided is a traveling device being inserted into an accommodator of a carriage including a traveling wheel, being coupled to the carriage, and traveling while pulling the carriage. The traveling device includes a driving wheel provided at a bottom of the traveling device, and a first guide roller contactable with the carriage when the traveling device is inserted into the accommodator of the carriage, at least one of a corner and a side surface of the traveling device.

### INCORPORATION BY REFERENCE

This application is based upon and claims the benefit of priority from the corresponding Japanese Patent Application No. 2019-002963 filed on Jan. 10, 2019, the entire contents of which are incorporated herein by reference.

### BACKGROUND OF THE INVENTION

### Field of the Invention

The present disclosure relates to a traveling device capable of autonomously traveling and a carriage pulled by the traveling device.

### Description of the Background Art

There is known an autonomously traveling robot (transport system) including: a traveling device including a drive device and wheels; and a carriage coupled to the traveling device, and the autonomously traveling robot travels autonomously while the traveling device pulls the carriage. In the transport system, the traveling device is accommodated to get under the carriage and coupled to the carriage, and the traveling device moves while pulling the carriage.

However, in a conventional transport system, when the carriage puts over the traveling device to couple the carriage to the traveling device, there is a problem in that the traveling device is damaged due to friction between the carriage and the traveling device. In particular, in a small carriage, a space for accommodating the traveling device is narrow, and thus, the above-described problem is significant.

An object of the present disclosure is to provide a traveling device and a carriage capable of being coupled without damaging the traveling device and the carriage.

### SUMMARY OF THE INVENTION

A traveling device according to an aspect of the present disclosure is inserted into an accommodator at a lower part of a carriage including a traveling wheel, is coupled to the carriage, and travels while pulling the carriage. The traveling device includes a driving wheel provided at a bottom of the traveling device, and a first guide roller contactable with the carriage when the traveling device is accommodated in the accommodator, at least one of a corner and a side surface of the traveling device.

A carriage according to another aspect of the present disclosure is coupled to and pulled by the traveling device, and the carriage includes the traveling wheel, the accommodator that accommodates the traveling device, and a second guide roller provided on an inner surface of the accommodate, the second guide roller contactable with the traveling device.

According to the present disclosure, it is possible to provide a traveling device and a carriage capable of being coupled without damaging the traveling device and the carriage.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view illustrating an overall configuration of a transport system according to an embodiment of the present disclosure;

FIG. 2 is a side view illustrating the overall configuration of the transport system according to the embodiment of the present disclosure;

FIG. 3 is a front view illustrating the overall configuration of the transport system according to the embodiment of the present disclosure;

FIG. 4 is a perspective view illustrating an overall configuration of a traveling device according to the embodiment of the present disclosure;

FIG. 5 is an enlarged plan view of a part of the traveling device according to the embodiment of the present disclosure;

FIG. 6A is a plan view illustrating a configuration of a guide roller of the traveling device according to the embodiment of the present disclosure;

FIG. 6B is a plan view illustrating a configuration of the guide roller of the traveling device according to the embodiment of the present disclosure;

FIG. 7 is a perspective view illustrating an overall configuration of a carriage according to the embodiment of the present disclosure;

FIG. 8 is an enlarged perspective view of a part of the carriage according to the embodiment of the present disclosure;

FIG. 9 is a side view illustrating the overall configuration of the carriage according to the embodiment of the present disclosure;

FIG. 10A is a plan view illustrating a configuration of a guide roller of the carriage according to the embodiment of the present disclosure;

FIG. 10B is a plan view illustrating a configuration of the guide roller of the carriage according to the embodiment of the present disclosure;

FIG. 11 is an enlarged perspective view of a part of the transport system according to the embodiment of the present disclosure;

FIG. 12A is a plan view illustrating a method of coupling the traveling device and the carriage according to the embodiment of the present disclosure;

FIG. 12B is a plan view illustrating the method of coupling the traveling device and the carriage according to the embodiment of the present disclosure;

FIG. 12C is a plan view illustrating the method of coupling the traveling device and the carriage according to the embodiment of the present disclosure;

FIG. 13 is a side view illustrating another configuration of the traveling device according to the embodiment of the present disclosure;

FIG. 14 is a perspective view illustrating another configuration of the traveling device according to the embodiment of the present disclosure;

FIG. 15 is an enlarged perspective view of a part of another configuration of the transport system according to the embodiment of the present disclosure;

FIG. 16 is a plan view illustrating an illumination range of search light from a distance measurement device according to the embodiment of the present disclosure;

FIG. 17 is a plan view illustrating a configuration of the carriage according to the embodiment of the present disclosure;

FIG. 18 is a plan view illustrating another configuration of the carriage according to the embodiment of the present disclosure;

FIG. 19 is a side view illustrating the other configuration of the carriage according to the embodiment of the present disclosure;

FIG. 20 is a plan view illustrating the other configuration of the carriage according to the embodiment of the present disclosure;

FIG. 21 is a side view illustrating another configuration of the carriage according to the embodiment of the present disclosure; and

FIG. 22 is a plan view illustrating a configuration of the traveling device according to the embodiment of the present disclosure.

### DESCRIPTION OF THE PREFERRED EMBODIMENTS

Below, an embodiment of the present disclosure will be described with reference to the attached drawings. It is noted that the following embodiment is an example in which the present disclosure is embodied, and does not intend to limit the technical scope of the present disclosure.

### Transport System 10

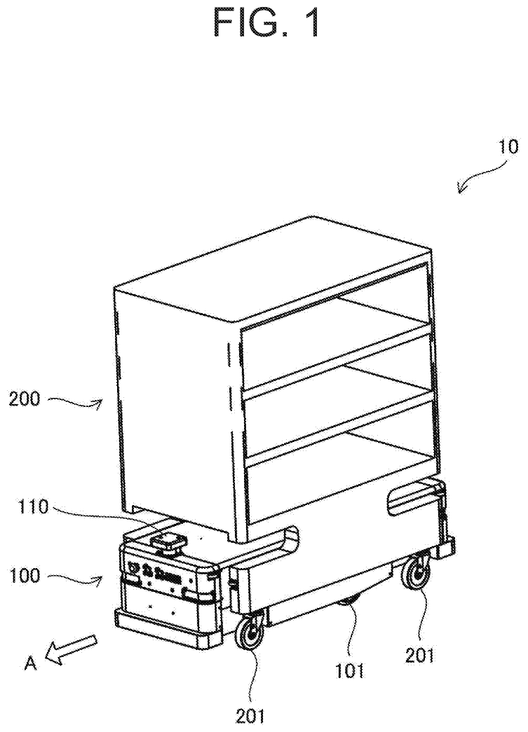

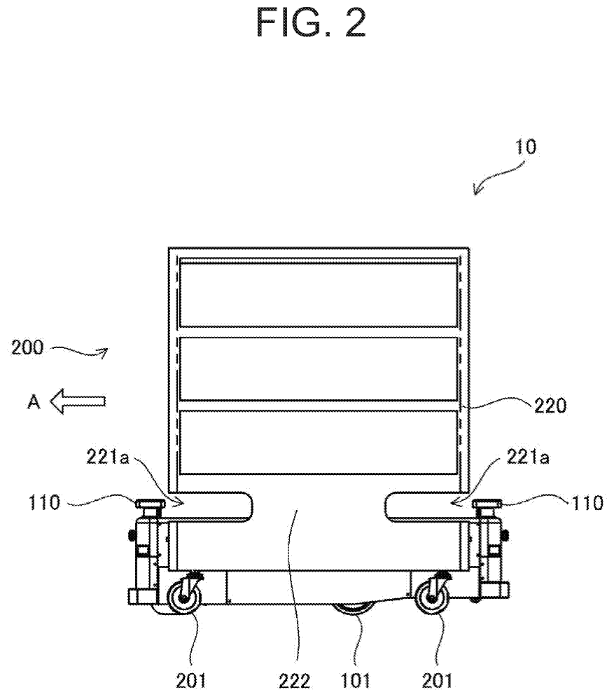

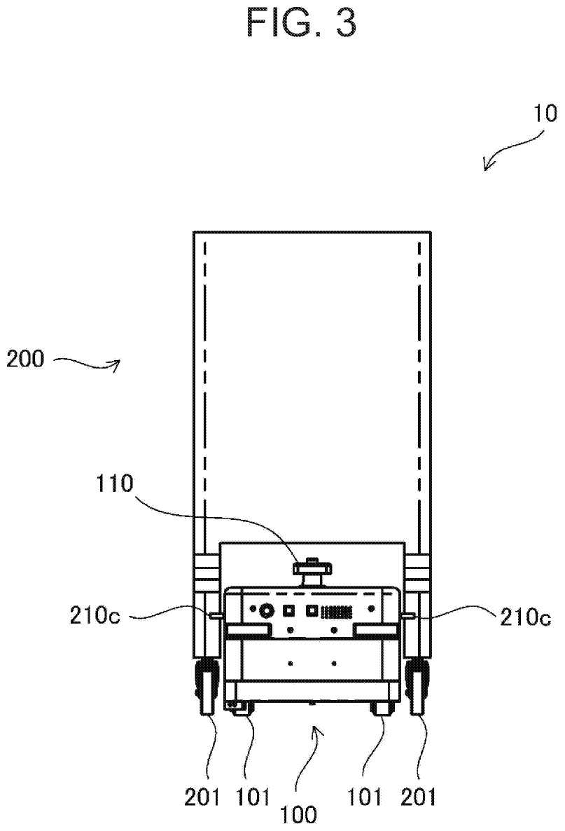

FIG. 1 is a perspective view illustrating an overall configuration of a transport system 10 according to the embodiment of the present disclosure. FIG. 2 is a side view illustrating the overall configuration of the transport system 10. FIG. 3 is a front view illustrating the overall configuration of the transport system 10.

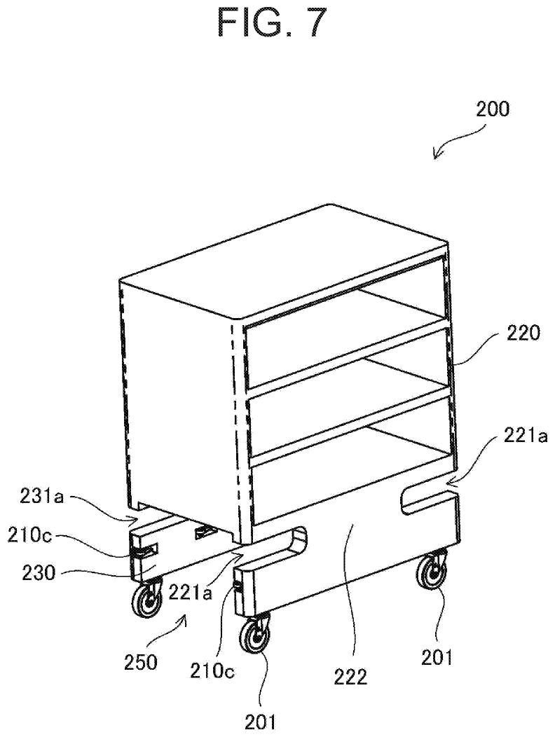

The transport system 10 includes a traveling device 100, a carriage 200, a controller (not illustrated) that controls driving of the traveling device 100, a storage (not illustrated) that stores various types of control programs and data, and the like. The transport system 10 is, for example, an automatic guided vehicle capable of unmanned travel. The traveling device 100 is inserted into an accommodate 230 (see FIG. 7) at a lower part of the carriage 200 including a traveling wheel 201 and coupled to the carriage 200. Then, the traveling device 100 autonomously moves to a target location while pulling the carriage 200 by driving a driving wheel 101. The transport system 10 may have a function of managing a location, quantity, weight, and the like of cargoes to be transported, or performing operation management. The function may be provided in a management device (not illustrated) that manages the transport system 10 or an operation terminal (not illustrated) that remotely operates the transport system 10.

Further, the transport system 10 may include an operation display (not illustrated) to be operated by an operator. The operation display includes a touch panel including an operation processor that operates the transport system 10 and a display that displays various types of setting screens and the like. The operation display receives various types of operations from the operator. For example, the operation display receives an operation for starting automatic travel, an operation for specifying a traveling speed and a traveling direction (moving direction) to cause the transport system 10 to manually travel, an operation for instructing to charge a battery, an operation for setting (reserving, revising, or the like) a travel route, and the like. Further, the operation display displays various types of screens including an operation screen for receiving the operation, a travel display screen for indicating a travel state of the transport system 10, and a setting screen for setting the travel route, or the like.

### Traveling Device 100

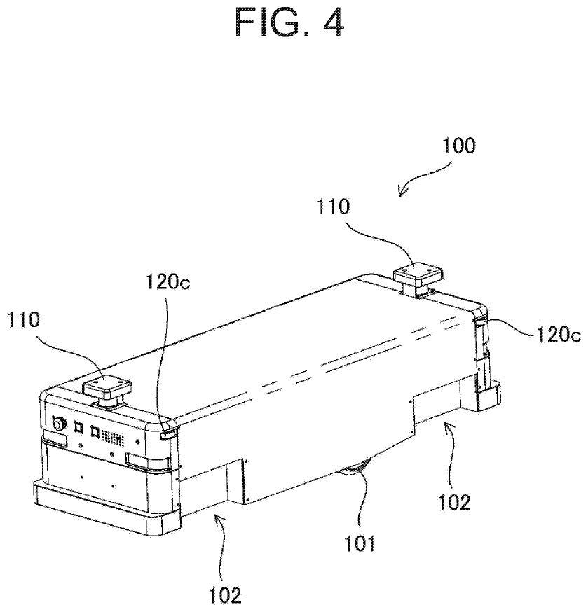

FIG. 4 is a perspective view illustrating a specific configuration of the traveling device 100. The traveling device 100 includes the driving wheel 101 provided at a bottom of a device main body, a driven wheel (not illustrated) rotatably provided at the bottom of the device main body, a distance measurement device 110 that detects an obstacle around the transport system 10, a battery (not illustrated) that supplies power to the device main body, and the like. The distance measurement device 110 is an example of a detection device of the present disclosure.

Here, the storage is a non-volatile storage including a semiconductor memory, a hard disk drive (HDD), a solid state Drive (SSD), or the like that store various types of information. For example, the storage stores a control program such as a program for causing the controller to execute a traveling process.

Further, picking information is stored in the storage. In the picking information, in which location in which storage shelf each of the cargoes to be transported is placed is indicated, and also how many of which cargoes, from among those cargoes, to be transported to which location is indicated. Further, cargo information related to a cargo is stored in the storage. The cargo information indicates the quantity of each of the cargoes stored in the storage shelf, the weight, the volume, and the like thereof.

Further, information necessary for the transport system 10 traveling is stored in the storage. For example, route information indicating a travel route on which the transport system 10 travels is stored in the storage. The travel route corresponds to, for example, a route on which a magnetic tape is applied on a floor surface on which the transport system 10 travels, or a route set (reserved) by the operator.

The control program is recorded non-temporarily on a computer-readable recording medium such as a USB, a CD, or a DVD. The control program is read by a reading device (not illustrated) such as a USB drive, a CD drive, or a DVD drive provided in the transport system 10, and stored in the storage. Further, the control program may be downloaded from an external device via a communication network and stored in the storage.

Further, the controller includes a control device for a CPU, a ROM, a RAM, and the like. The CPU is a processor that executes various types of arithmetic processes. The ROM is a non-volatile storage in which a control program such as BIOS and OS for causing the CPU to execute various types of arithmetic processes is stored in advance. The RAM is a volatile or non-volatile storage that stores various types of information, and is used as a temporary storage memory (working area) for various types of processes executed by the CPU. The controller controls the transport system 10 by causing the CPU to execute the various types of control programs stored in advance in the ROM or the storage.

Specifically, the controller acquires operation information corresponding to an operation of the operator on the operation display. Further, the controller switches a travel mode of the transport system 10, based on the operation information. Specifically, if the operator performs, on the operation display, an operation for starting automatic travel, the controller sets the travel mode of the transport system 10 to an automatic travel mode. Further, if the operator performs, on the operation display, an operation for ending automatic travel or an operation for starting manual travel, the controller sets the travel mode of the transport system 10 to a manual travel mode.

Further, the controller controls a travel operation of the transport system 10 based on the travel mode. For example, if the travel mode is set to the automatic travel mode, the controller causes the transport system 10 to travel according to a travel route corresponding to the route information stored in the storage. Specifically, the controller transmits, to the traveling device 100, a travel instruction corresponding to the travel route.

Further, if the travel mode is set to the manual travel mode, the controller causes the transport system 10 to travel based on an operation of the operator on the operation display or the operation terminal (not illustrated). For example, the controller transmits, to the traveling device 100, a travel instruction according to the operation of the operator on the operation terminal.

Further, the controller notifies the operation display and the like of information indicating a current state such as the travel state of the transport system 10. For example, the controller displays, on the operation display, information indicating a current travel plan and travel position (current travel position) of the transport system 10.

Further, the controller controls the moving direction of the transport system 10 based on information about a distance measured by the distance measurement device 110. For example, if the distance measurement device 110 detects an obstacle in the moving direction of the transport system 10, the controller changes the moving direction of the transport system 10 so that the transport system 10 avoids the obstacle.

The distance measurement device 110 emits search tight in a horizontal direction over a predetermined angle to detect a reflected light of the search light to detect the presence or absence of an obstacle (target object) and to measure the distance to the obstacle. The search light is, for example, laser light. For example, two distance measurement devices 110 are installed at an end on a side in the moving direction (front side) of the transport system 10 and at an end on a side (rear side) opposite to the side in the moving direction. Further, each of the distance measurement devices 110 is arranged at a center position in a width direction when the traveling device 100 is viewed from the front (see FIG. 3). It is noted that the number of the distance measurement devices 110 is not limited, and it is sufficient that at least one distance measurement device 110 is installed. In the present embodiment, the distance measurement device 110 at the front side and the distance measurement device 110 at the rear side (see FIG. 2) each emit the search light in a range of 270 degrees to detect an obstacle in an illumination range. As described above, in the present embodiment, the two distance measurement devices 110 detect an obstacle in a predetermined range around the transport system 10.

It is noted that the two distance measurement devices 110 may be arranged on a diagonal line passing through the corners and the center of the traveling device 100 when the traveling device 100 is viewed from above, and may be arranged more closely to the center so that the distance between the two distance measurement devices 110 is smaller than that illustrated in FIGS. 3 and 4. Further, the distance measurement device 110 may be arranged on an upper surface of the traveling device 100 or may be arranged in a region between a bottom surface and the upper surface of the traveling device 100.

Further, the traveling device 100 includes, at least one of the corner and the side surface of the traveling device 100, a guide roller 120c (corresponding to a first guide roller of the present disclosure) contactable with the carriage 200 when the traveling device 100 is inserted into the accommodator 250 at the lower part of the carriage 200. In the example illustrated in FIG. 4, the guide roller 120c is provided at each of four corners of the traveling device 100. The guide roller 120c includes a free wheel. The free wheel is rotatable in the horizontal direction since a roller shaft of the guide roller 120c extending in a direction perpendicular to the floor surface is supported by a casing of the traveling device 100. Further, an outer periphery of the guide roller 120c is covered with an elastic member such as a rubber, and thus, it is possible to prevent damage to an object (for example, the carriage 200) contacted by the guide roller 120c.

Further, a later-described recess 102 is provided on the side surface of the traveling device 100. The recess 102 is provided at a position corresponding to the traveling wheel 201 of the carriage 200.

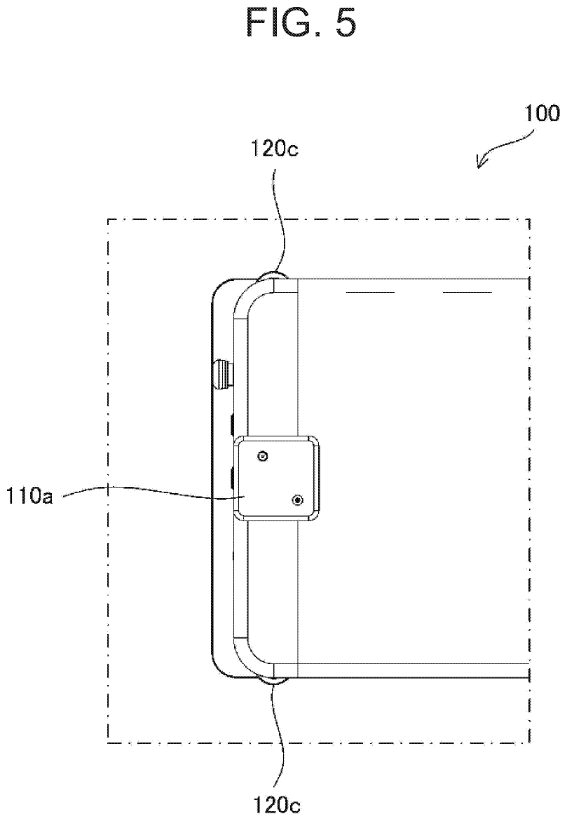

FIG. 5 is a plan view of the traveling device 100 viewed from above. The guide roller 120c is provided to partially protrude outwardly from the corner and the side surface (side surface across the moving direction of the traveling device 100) of the traveling device 100, and the guide roller 210c is provided to contact a contact object before the side face (casing) of the traveling device 100 contacts the contact object (for example, the carriage 200).

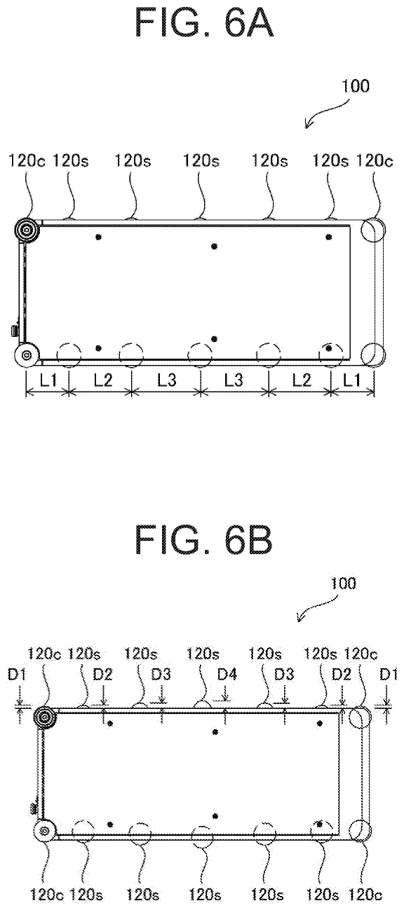

The traveling device 100 may further include one or a plurality of guide rollers 120s (corresponding to the first guide roller of the present disclosure) on each of the side surfaces. That is, the guide rollers of the traveling device 100 may be arranged at each of four corners and at both aide surfaces. Further, for example, the plurality of guide rollers 120s may be arranged at equal intervals or at different intervals at the side surface. For example, in the example illustrated in FIG. 6A, the plurality of guide rollers 120s are arranged so that the interval between two adjacent guide rollers 120s is narrower, the closer to an insertion opening (accommodation opening) of the accommodator 250 (see FIG. 7) of the carriage 200, that is, the closer to the end of the traveling device 100. That is, in FIG. 6A, the plurality of guide rollers 120s are arranged to satisfy a relationship of distance L1<distance L2<distance L3. It is noted that the distance L1 indicates the distance from the guide roller 120c at the corner to the guide roller 120s at the side surface.

Further, lengths by which the plurality of guide rollers 120s protrude from the side surface may be identical or different. For example, in the example illustrated in FIG. 6B, when the traveling device 100 is viewed from above, the plurality of guide rollers 120s are arranged so that the lengths by which the guide rollers 120s protrude from the side surface are shorter, the closer to the insertion opening of the accommodator 250 of the carriage 200, that is, the closer to the end of the traveling device 100. That is, in FIG. 6B, the plurality of guide rollers 120s are arranged to satisfy a relationship of length D1<length D2<length D3<length D4. It is noted that the length D1 indicates a length by which the guide roller 120c at the corner protrudes from the side surface.

Further, the guide roller 120c and the plurality of guide rollers 120s are arranged at the same height from the floor surface. Accordingly, for example, if the traveling device 100 is inserted into the accommodator 250 of the carriage 200, a position where the guide roller 120c contacts the carriage 200 and a position where the guide rollers 120s contact the carriage 200 are matched.

It is noted that FIGS. 6A and 6B illustrate a configuration in which the traveling device 100 is insertable into the carriage 200 from both sides of the carriage 200. That is, FIGS. 6A and 6B illustrate a configuration in which it is possible to move the carriage 200 from the left side of the traveling device 100 illustrated in FIGS. 6A and 6B to accommodate the traveling device 100 in the accommodator 250 of the carriage 200 and in which it is possible to move the carriage 200 from the right side of the traveling device 100 to accommodate the traveling device 100 in the accommodator 250 of the carnage 200.

Further, the traveling device 100 includes a stopper (not illustrated) for coupling with the carriage 200. The stopper is provided on the upper surface of the traveling device 100, for example. When the traveling device 100 is inserted into the accommodator 230 of the carriage 200, the traveling device 100 and the carriage 200 are coupled to each other by the stopper engaging with the carriage 200.

### Carriage 200

FIG. 7 is a perspective view illustrating a specific configuration of the carriage 200. The carriage 200 is a shelf (wagon) on which a cargo or the like is placed, and includes the traveling wheel 201 rotatably attached to the bottom at each of four corners of the carriage 200. The carriage 200 is self-supported by the four traveling wheels 201 and is configured to be manually moved by the operator.

The carriage 200 includes a side surface 220 across an insertion direction in which the traveling device 100 is inserted into the accommodator 250 at the lower part of the carnage 200, and the side surface 20 includes two side surfaces 20. An opening for putting in and out a cargo and the like is formed at the upper part of each of the side surfaces 220, and a recess 221a (an example of a passing part of the present disclosure) through which the search light from the distance measurement device 110 passes is formed at the lower part of each of the side surfaces 220. There is formed with the recess 221a on a side in a moving direction A, the recess 221a on a side opposite to the side in the moving direction A, and a coupling part 222 arranged between the two recesses 221a, at each of the side surfaces 220. As described above, each of the side surfaces 220 includes a housing (shelf) above the recess 221a, a leg below the recess 221a, and the coupling part 222 adjacent to the recess 221a and coupling the housing and the leg. Further, the recess 221a is provided at a height of the side surface 220 at which the side surface 220 illuminated with the search light. Further, the recess 221a has a shape cut out front an end of the side surface 220.

Further, the guide roller 210c (corresponding to a second guide roller of the present disclosure) is provided below the recess 221a and the coupling part 222 at the side surface 220 (at the leg). Specifically, the guide roller 210c is provided on an inner surface 230 of the leg of the carriage 200 into which the traveling device 100 is inserted to contact the traveling device 100. For example, the guide roller 210c is arranged at a corner of the insertion opening into which the traveling device 100 is inserted. In a configuration in which the traveling device 100 is inserted into the carriage 200 from one side of the carriage 200, the guide roller 210c is arranged at two corners of one insertion opening. Further, in a configuration in which the traveling device 100 is insertable into the carriage 200 from both sides (the front and the rear) of the carriage 200, the guide roller 210c is arranged at four corners of both the (front and rear) insertion openings.

The traveling wheels 201 are provided at the corners of the bottom of each of the side surfaces 220. All of the four traveling wheels 201 may include a turnable wheel (turning caster), or two of the traveling wheels 201 may include a turning caster and two of the traveling wheels 201 may include a not-turnable wheel (fixed caster).

Further, the accommodator 250 (see FIG. 7) being a predetermined space into which the traveling device 100 is insertable, is formed at a lower part of the carriage 200. The accommodator 250 is a space surrounded by the leg and the housing. For example, the operator moves the carriage 200 while pushing the carriage 200 by hand so that the traveling device 100 being stopped on the floor surface is accommodated in the accommodator 250 of the carriage 200. Then, the stopper provided on the upper surface of the traveling device 100 is engaged with the carriage 200, and thus the traveling device 100 and the carriage 200 are coupled. Afterwards, when the traveling device 100 is driven, the carriage 200 is pulled by the traveling device 100 and moves to a target location.

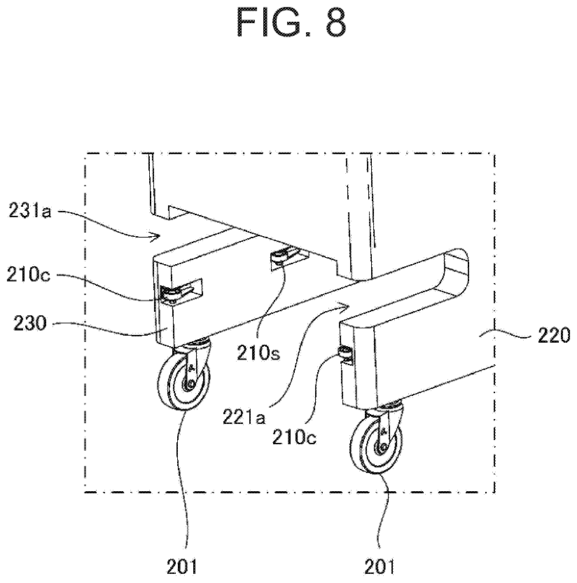

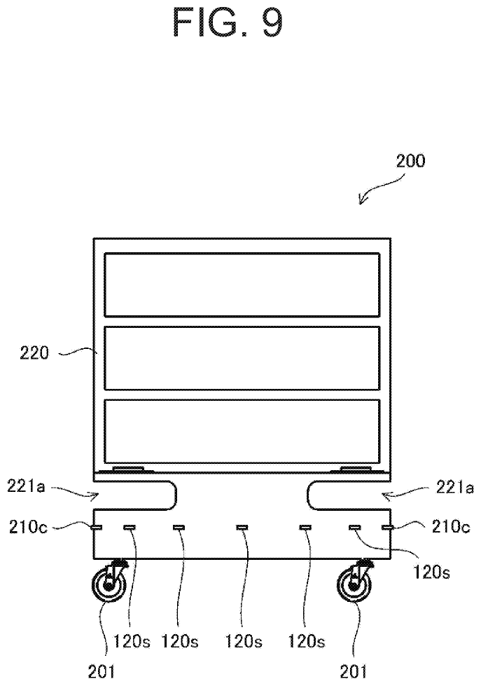

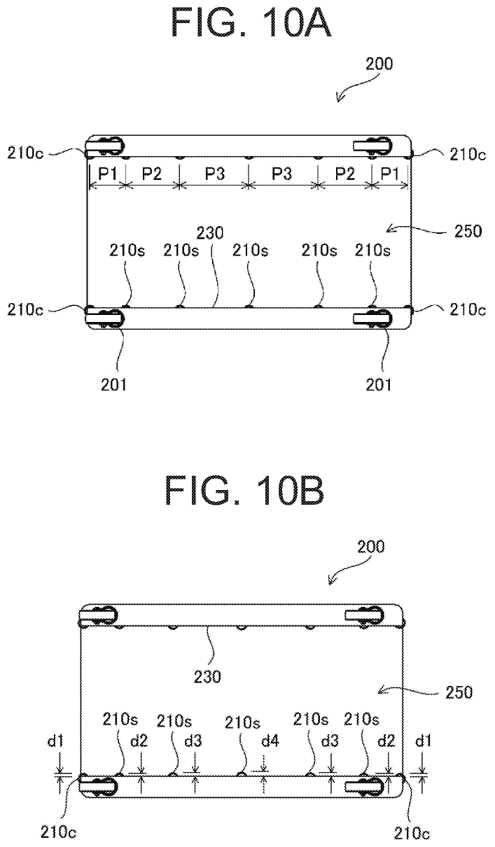

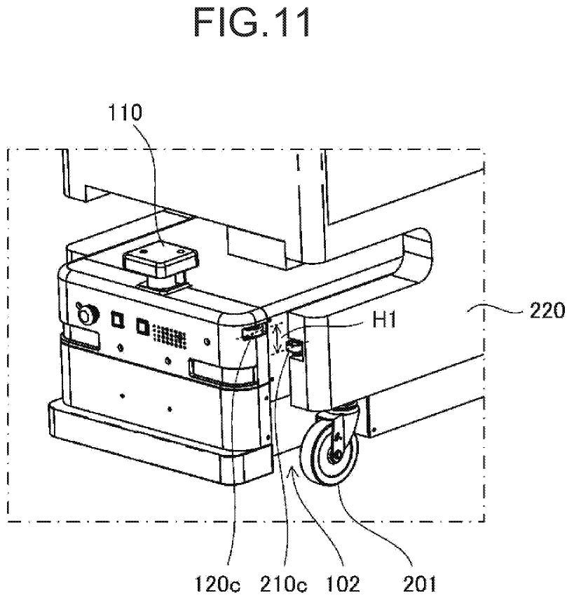

Further, the carriage 200 may further include one or a plurality of guide rollers 210s (corresponding to the second guide roller of the present disclosure) on the inner surface 230 of the accommodator 250 (see FIGS. 8 and 9). For example, the plurality of guide rollers 210s may be arranged, on the inner surface 230, at equal intervals or at different intervals. For example, in the example illustrated in FIG. 10A, the plurality of guide rollers 210s are arranged so that the interval between two adjacent guide rollers 210s is narrower, the closer to the insertion opening of the accommodator 250 of the carriage 200, that is, the closer to an end of the carriage 200. That is, in FIG. 10A, the plurality of guide rollers 210s are arranged to satisfy a relationship of distance P1<distance P2<distance P3. It is noted that the distance P1 indicates the distance from the guide roller 210c at the corner to the guide roller 210s at the inner surface 230.

Further, the lengths by which the plurality of guide rollers 210s protrude from the inner surface 230 may be identical or maybe different. For example, in the example illustrated in FIG. 10B, when the carriage 200 is viewed from above, the plurality of guide rollers 210s are arranged so that the lengths by which the guide rollers 210s protrude from the inner surface 230 are shorter, the closer to the insertion opening of the accommodator 250 of the carriage 200, that is, the closer to the end of the carriage 200. That is, in FIG. 10B, the plurality of guide rollers 210s are arranged to satisfy a relationship of length d1<length d2<length d3<length d4. It is noted that the length d1 indicates a length by which the guide roller 210c at the corner protrudes from the corner and the inner surface 230.

Further, the guide roller 210c and the guide rollers 210s are arranged at the same height from the floor surface. Accordingly, for example, when the traveling device 100 is inserted into the accommodator 250 of the carriage 200, a position where the guide roller 210c contacts the traveling device 100 and a position where the guide rollers 210s contact the traveling device 100 are matched.

It is noted that FIGS. 10A and 10B illustrate a configuration in which the traveling device 100 is insertable into the carriage 200 from both sides of the carriage 200. That is, FIGS. 10A and 10B illustrate a configuration in which it is possible to move the carriage 200 illustrated in FIGS. 10A and 10B in the left direction to accommodate the traveling device 100 in the accommodator 250 of the carriage 200 and in which it is possible to move the carriage 200 in the right direction to accommodate the traveling device 100 in the accommodator 250 of the carriage 200.

Further, as illustrated in FIG. 11, the guide roller 210c and the guide roller 210s of the carriage 200 are arranged at a height from the floor surface different from that of the guide roller 120c and the guide roller 120s of the traveling device 100. For example, as illustrated in FIG. 11, the guide roller 210c and the guide roller 120c are arranged so that the height from the floor surface is shifted by H1. Accordingly, the guide roller 210c and the guide roller 120c do not contact each other, the guide roller 210c is contactable with the traveling device 100, and the guide roller 120c is contactable with the carriage 200.

### Coupling Method

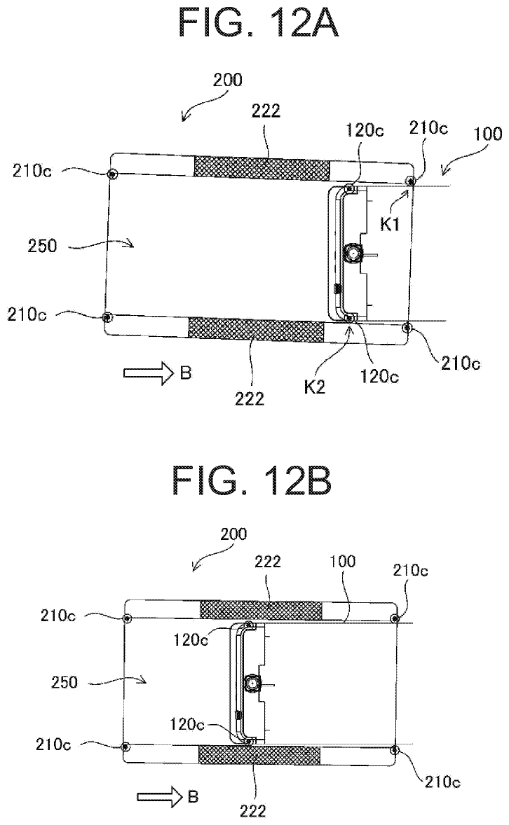

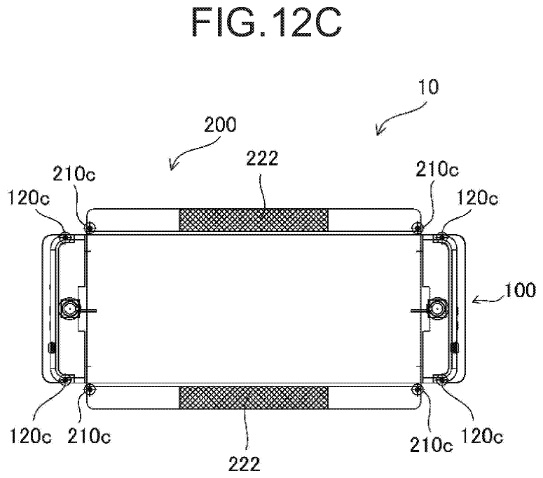

FIGS. 12A to 12C are diagrams illustrating a procedure of a method of coupling the traveling device 100 and the carnage 200. If the traveling device 100 and the carriage 200 are coupled to each other, the operator pushes by hand and moves the carriage 200 to accommodate the traveling device 100 in the accommodator 250 of the carriage 200.

Specifically, as illustrated in FIG. 12A, the operator grips the casing of the carriage 200 and moves the carriage 200 in a direction B, and inserts a front end of the stopped traveling device 100 into the insertion opening of the accommodator 250 of the carriage 200. When the front end of the traveling device 100 is inserted into the accommodator 250 of the carriage 200, the guide roller 210c of the carriage 200 contacts the casing (side surface) of the traveling device 100 (K1 in FIG. 12A) and the guide roller 120c of the traveling device 100 contacts the casing (inner surface 230) of the carriage 200 (K2 in FIG. 12A). Accordingly, the guide roller 120c and the guide roller 210c rotate, and the front end of the traveling device 100 is led into the accommodator 250 of the carriage 200.

If the operator pushes the carriage 200 in the direction B subsequently, as illustrated in FIG. 12B, the guide roller 120c and the guide roller 210c rotate in response to a pushing force of the operator, and thus, the traveling device 100 is led into an interior of the accommodator 250 of the carriage 200. That is, in response to the pushing force of the operator, the carnage 200 moves in the direction B while the guide roller 210c contacts the traveling device 100 and rotates and the guide roller 120c contacts the carriage 200 and rotates, and thus, the traveling device 100 is led into the interior of the accommodator 250.

If the operator pushes the carriage 200 in the direction B subsequently, as illustrated in FIG. 12C, the carriage 200 moves further to a predetermined position (for example, a center position) with respect to the traveling device 100 and the traveling device 100 is inserted into the accommodate 250 of the carriage 200. If the carriage 200 is arranged at the predetermined position with respect to the traveling device 100, the guide roller 210c is contactable with the side surface of the traveling device 100 and the guide roller 120c is arranged outside of the carriage 200. Further, if the carriage 200 is arranged at the predetermined position with respect to the traveling device 100, the stopper of the traveling device 100 engages with the carriage 200, and thus, the traveling device 100 and the carriage 200 are coupled to each other. Accordingly, the transport system 10 autonomously travels. Further, if the traveling device 100 and the carriage 200 are coupled to each other, the guide roller 210c of the carriage 200 contacts the side surface of the traveling device 100, and thus, rattling of the carriage 200 is suppressed.

Here, in the transport system 10 according to the present disclosure, it is sufficient that the guide roller is provided in at least one of the traveling device 100 and the carriage 200. Further, if the guide roller is provided in the traveling device 100, it is sufficient that the guide roller is provided at least one of the corner and the side surface of the traveling device 100. Further, if the guide roller is provided in the carriage 200, it is sufficient that the guide roller is provided at least one of the corner and the side surface of the carriage 200. Further, as illustrated in FIGS. 12A to 12C, the guide rollers may be provided at each of four corners of the traveling device 100 and at each of the four corners of the carriage 200.

According to the transport system 10 of the present embodiment, the traveling device 100 is smoothly inserted and accommodated into the carriage 200 by the rotation of the guide roller. Thus, the traveling device 100 and the carriage 200 are coupled to each other without being damaged. Further, as illustrated in FIG. 3, the width of the carriage 200 is reduced to fit the width of the traveling device 100. That is, it is possible to realize the transport system 10 in a small size.

Here, at an initial stage where the insertion of the traveling device 100 into the carriage 200 starts, the traveling device 100 is easily inserted obliquely with respect to the carriage 200, as illustrated in FIG. 12A. Therefore, the traveling device 100 and the carriage 200 are easily contactable each other, especially near the insertion opening. On the other hand, if the traveling device 100 has the configuration illustrated in FIG. 6A, or if the carriage 200 has the configuration illustrated in FIG. 10A, the guide rollers are arranged at a high density near the insertion opening, and thus, it is possible to prevent a contact between the traveling device 100 and the carriage 200 near the insertion opening. Further, if the traveling device 100 has the configuration illustrated in FIG. 6B, or if the carriage 200 has the configuration illustrated in FIG. 10B, it is possible to lead the traveling device 100 toward a center (toward the center viewed from the front) of the accommodator 250 of the carriage 200, and thus, it is possible to prevent the contact between the traveling device 100 and the carriage 200 near the insertion opening.

Further, according to the transport system 10 of the present embodiment, the guide roller is interposed between the traveling device 100 and the carriage 200, and thus, it is possible to prevent a contact between the traveling device 100 and the carriage 200 during an operation (during travel) of the transport system 10 after the traveling device 100 and the carriage 200 are coupled to each other.

The transport system 10 of the present disclosure is not limited to the above-described configuration.

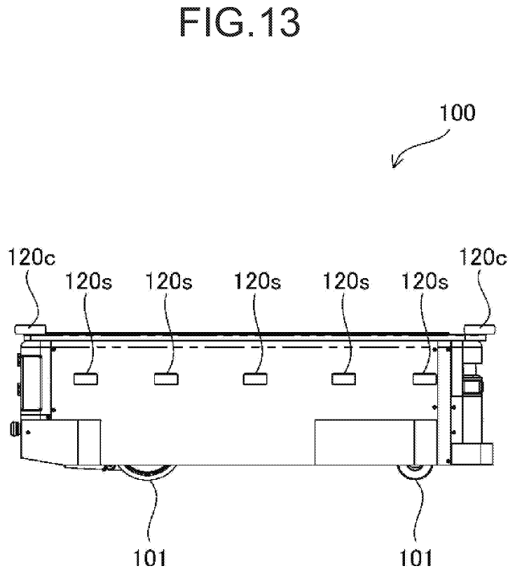

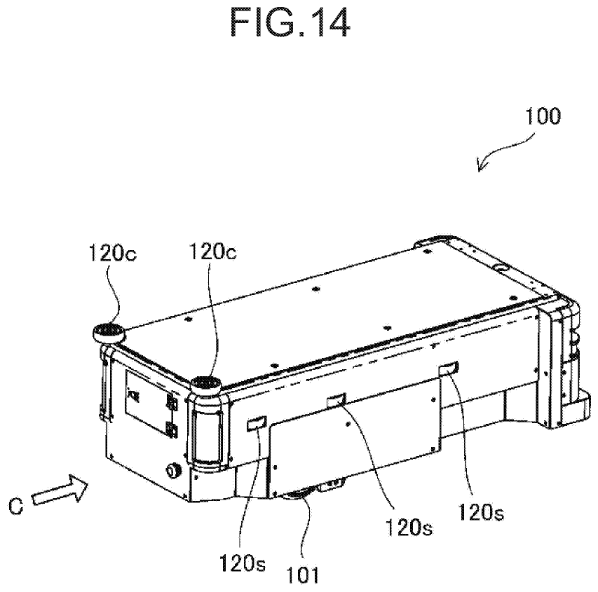

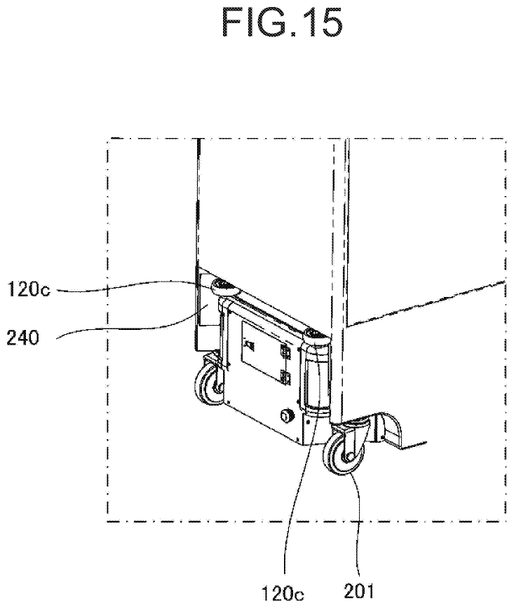

As another embodiment, as illustrated in FIG. 13, in the traveling device 100, the guide roller 120c may be provided on the upper surface of the traveling device 100, for example. Further, the traveling device 100 may be configured to be inserted into the carriage 200 from one specific side. For example, as illustrated in FIG. 14, the carriage 200 moves in a direction C toward the traveling device 100 and accommodates the traveling device 100 in the accommodate 250 of the carriage 200. In this configuration, it is sufficient to arrange the guide toller 120c of the traveling device 100 only on an insertion opening side.

Further, in the configuration (see FIG. 14) in which the carriage 200 is moved and coupled to the traveling device 100 from the one side, the plurality of guide rollers 120s are arranged so that the interval between two adjacent guide rollers 120s is narrower, the closer to the insertion opening (accommodation opening) of the accommodator 250 (see FIG. 7) of the carriage 200, that is, the closer to a front end of the traveling device 100, and so that the interval between two adjacent guide rollers 120s is wider, the farther from the insertion opening, that is, the closer to a rear end of the traveling device 100. Further, the plurality of guide rollers 120s are arranged so that the lengths by which the guide rollers 120s protrude from the side surface are shorter, the closer to the insertion opening (accommodation opening) of the accommodator 250 (see FIG. 7) of the carriage 200, that is, the closer to the front end of the traveling device 100, and so that the lengths by which the guide rollers 120s protrude from the side surface are longer, the farther from the insertion owning, that is, the closer to the rear end of the traveling device 100.

Similarly, the plurality of guide rollers 210s are arranged so that the interval between two adjacent guide rollers 210s is narrower, the closer to the insertion opening of the accommodator 250 of the carnage 200, that is, the closer to the end of the carriage 200, and so that the interval between two adjacent guide rollers 210s is wider, the farther from the insertion opening, that is, the closer to a rear end of the carriage 200. Further, the plurality of guide rollers 210s are arranged so that the lengths by which the guide rollers 210s protrude from the inner surface 230 are shorter, the closer to the insertion owning of the accommodator 250 of the carriage 200, that is, the closer to the end of the carriage 200, and so that the lengths by which the guide rollers 210s protrude from the inner surface 230 are longer, the farther from the insertion opening, that is, the closer to the rear end of the carriage 200.

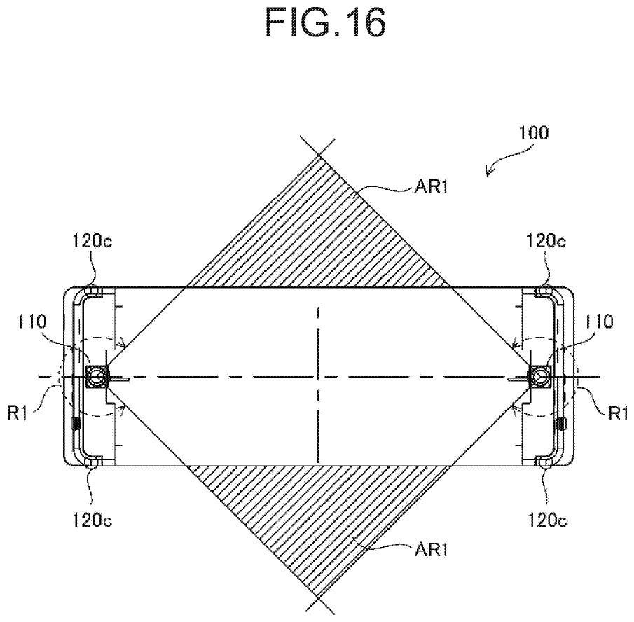

Further, as another embodiment, as illustrated in FIG. 15, for example, a side plate 240 contactable with the guide roller 120c of the traveling device 100 may be provided on the inner surface 230 of the carriage 200, for example. The side plate 240 is made of a hard material such as metal or resin, for example. Further, it is preferable that the side plate 240 is formed in a taper shape widening from the inside of the accommodator 250 toward the insertion opening. Accordingly, the guide roller 120c rotates in contact with the side plate 210, and thus, it is possible to easily lead the traveling device 100 to the accommodator 250 of the carriage 200, and it is possible to smoothly insert the traveling device 100 into the carriage 200.

### Recess 221a of Carriage 200

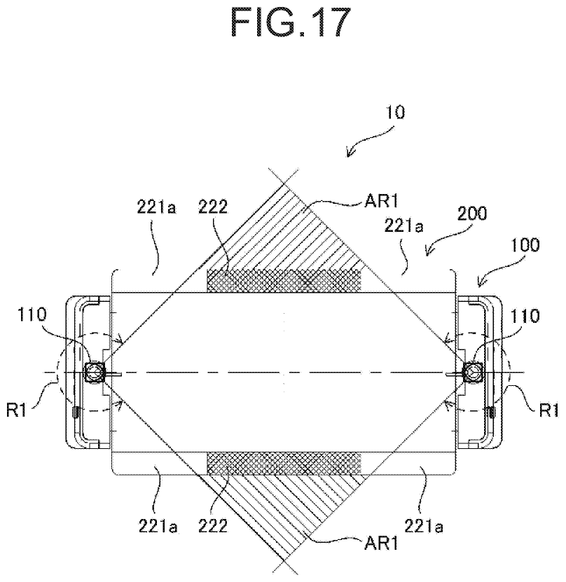

As illustrated in FIG. 16, the distance measurement devices 110 are installed at two locations, that is, at the side in the moving direction (front) and at the rear of the transport system 10. Each of the distance measurement devices 110 emits the search light in a range of 270 degrees (R1 illustrated in FIG. 16). Therefore, the range R1 illustrated in FIG. 16 is an illumination region illuminated with the search light, and a range AR1 illustrated in FIG. 16 is a non-illumination region illuminated with no search light. As illustrated in FIG. 2, the carriage 200 includes the recess 221a to maximize the function of the illumination region as a detection region for detecting an obstacle. Specifically, as illustrated in FIG. 17, when the carriage 200 and the traveling device 100 are viewed from above, at least a part of the recess 221a is arranged in the illumination region R1 of the search light, and the coupling part 222 is arranged in the non-illumination region AR1 of the search light. According to the above-described configuration, the carriage 200 does not block the search light emitted from the distance measurement device 110, and thus, it is possible to expand a detection range of the distance measurement device 110. Therefore, it is possible to prevent a decrease in the detection accuracy of obstacles in the distance measurement device 110 provided in the traveling device 100.

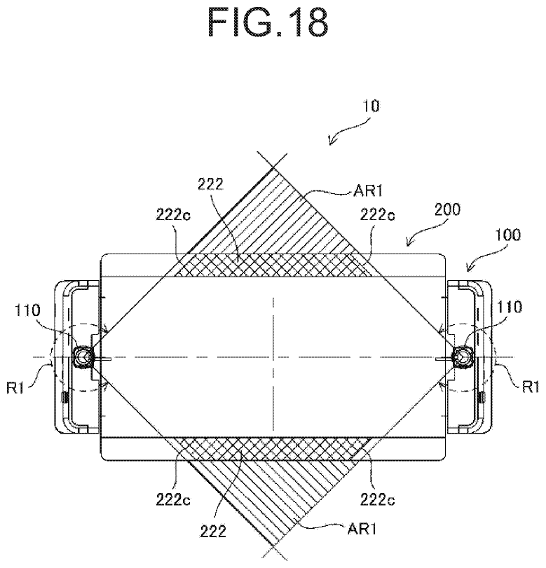

As another embodiment of the carriage 200, for example, as illustrated in FIG. 18, an end of the coupling part 222 may have an inclined surface 222c that is inclined in an illumination direction of the search light. As a result, it is possible to expand the detection range of the distance measurement device 110, and it is possible to increase a surface area of the coupling part 222 of the carriage 200 to ensure strength. It is noted that the end of the coupling part 222 is not limited to the inclined surface and may be a curved surface.

In the configurations of FIGS. 17 and 18, the two distance measurement devices 110 may be arranged, for example, toward the center on the upper surface of the traveling device 100, so that the distance between the two distance measurement devices 110 is closer. Accordingly, it is possible to shrink the non-illumination region AR1, and thus, it is possible to further expand the detection range of the distance measurement device 110.

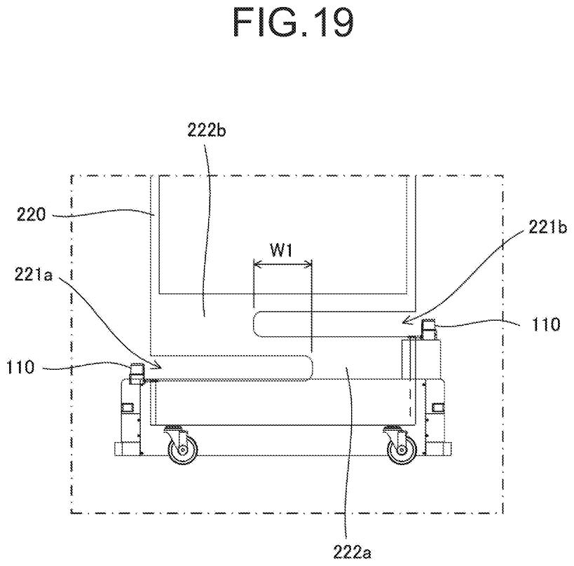

As another embodiment, installation heights of the two distance measurement devices 110 may be different from each other. Specifically, as illustrated in FIG. 19, one of the distance measurement devices 110 (on the light side in the drawing) is arranged at a higher position than the other of the distance measurement devices 110 (on the left side in the drawing). Accordingly, the height (horizontal height) of the search light in the illumination direction differs between the distance measurement devices 110. In this case, as illustrated in FIG. 19, the recess 221a on the lower side provided corresponding to the distance measurement device 110 on the left side is formed from the left end of the carriage 200 to the right side from the center, and a coupling part 222a on the lower side is formed on the right end of the carriage 200. Further, a recess 221b on the upper side provided corresponding to the distance measurement device 110 on the right side is formed from the light end of the carriage 200 to the left side from the center, and a coupling part 222b on the upper side is formed on the left end of the carriage 200. That, is, the recesses 221a and 221b are provided at different heights from each other. Further, when the carriage 200 is viewed from above, the two recesses 221a and 221b are provided in the side surface 220 so that parts of each of the recesses 221a and 221b (width W1 illustrated in FIG. 19) overlap each other near the center. Further, the two coupling parts 222a and 222b are provided at both ends of the side surface 220 to be far away from each other.

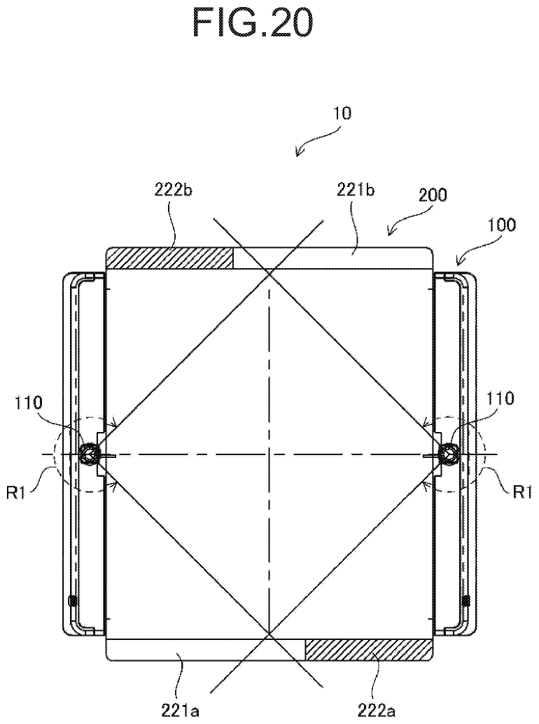

FIG. 20 illustrates a plan view of FIG. 19. It is noted that, in FIG. 20, for convenience, the lower half of the drawing illustrates the recess 221a and the coupling part 222a formed at the lower side of the carriage 200 (see FIG. 19), and the upper half of the drawing illustrates the recess 221b and the coupling part 222b formed at the upper side of the carriage 200 (see FIG. 19). According to the above-described configuration, it is possible to shrink the non-illumination region AR1 (see FIG. 16). The entire vicinity of the transport system 10 is illuminated with the search light from each of the two distance measurement devices 110. That is, all regions around the transport system 10 are the illumination region R1. Therefore, it is possible to detect an obstacle in all directions around the transport system 10.

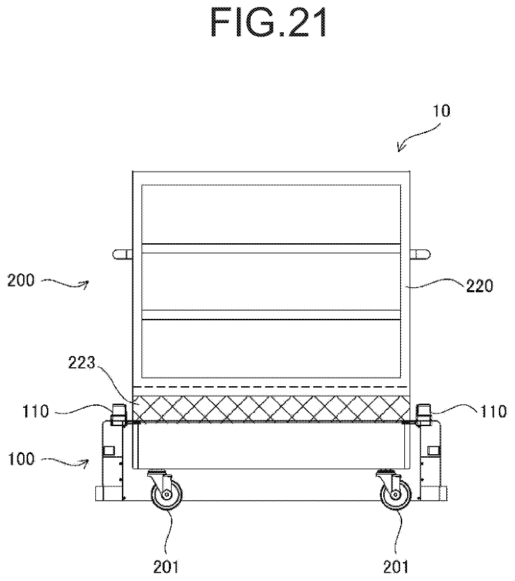

As another embodiment, in the carriage 200, at least a part of a portion of the side surface 220 illuminated with the search light from the distance measurement device 110 may be formed of a material transmitting light. For example, as illustrated in FIG. 21, the entire surface of a portion 223 (an example of the passing part of the present disclosure) of the side surface 220 illuminated with the search light may be formed of a transparent resin material. Further, a part of the portion 223 may be formed of the transparent resin material. Accordingly, the search light is not blocked by the carriage 200, and thus, a wide range around the transport system 10 is used as the detection region. Further, it is possible to prevent a decrease in strength of the carriage 200.

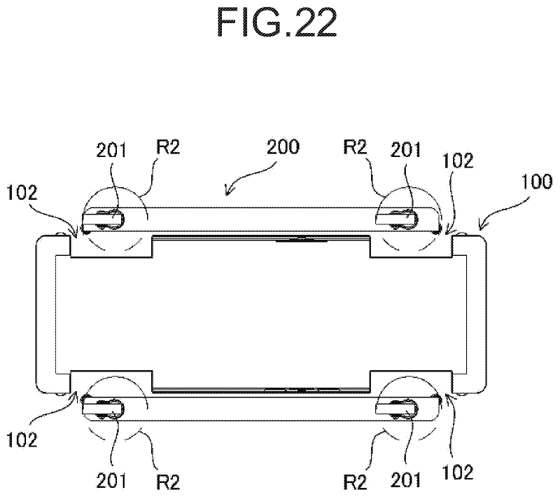

As another embodiment, as illustrated in FIG. 4, the traveling device 100 may include may include, on the side surface, the recess 102 corresponding to the movable range of the traveling wheel 201 of the carriage 200. Specifically, as illustrated in FIG. 22, the recess 102 is provided on the side surface to be arranged near the traveling wheel 201 when the traveling device 100 and the carriage 200 are coupled. Further, the recess 102 is formed to not overlap with a turning region R2 (see FIG. 22) of the traveling wheel 201. Accordingly, it is possible to prevent the traveling wheel 201 from contacting the traveling device 100 if the traveling wheel 201 turns and moves.

A method of coupling the traveling device 100 and the carriage 200 is not limited to the above-described method. As another embodiment, the traveling device 100 may move autonomously in accordance with an instruction from the controller, enter the accommodator 250 of the carriage 200, and be coupled to the carriage 200.

It is noted that, in the transport system according to the present disclosure, within the scope of the invention described in claims, the embodiments described above may be freely combined, or the embodiments may be appropriately modified or some of the embodiments may be omitted.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A traveling device being inserted into an accommodator at a lower part of a carriage including a traveling wheel, being coupled to the carriage, and travelling while pulling the carriage, the traveling device comprising:
a driving wheel provided at a bottom of the traveling device; and
a first guide roller contactable with the carriage when the traveling device is accommodated in the accommodator, at least one of a corner and a side surface of the traveling device.

2. The traveling device according to claim 1, wherein the corner includes four cornets, the side surface includes two side surfaces across a moving direction of the traveling device, and the first guide roller is arranged at each of the four corners and the two side surfaces.

3. The traveling device according to claim 1, wherein the first guide roller includes a plurality of first guide rollers, and the plurality of first guide rollers are arranged at same height from a floor surface.

4. The traveling device according to claim 1, wherein the first guide roller includes a plurality of first guide rollers, and when the traveling device is viewed from above, the plurality of first guide rollers protrude by same length from the corner or the side surface.

5. The traveling device according to claim 1, wherein the first guide roller includes a plurality of first guide rollers, and the plurality of first guide rollers are arranged on the side surface, and
the plurality of first guide rollers are arranged so that an interval between two adjacent ones of the plurality of first guide rollers is narrower, the closer to an insertion opening of the accommodator.

6. The traveling device according to claim 1, wherein the first guide roller includes a plurality of first guide rollers, the plurality of first guide rollers are arranged on the side surface, and
when the traveling device is viewed from above, the plurality of first guide rollers are arranged so that length by which the first guide roller protrude from the side surface is shorter, the doser to an insertion opening of the accommodator.

7. The traveling device according to claim 1, wherein an outer periphery of the first guide roller is covered with an elastic member.

8. The traveling device according to claim 1, wherein the first guide roller contacts a side plate provided on an inner surface of the accommodator.

9. The traveling device according to claim 1, wherein a recess corresponding to a movable range of the traveling wheel is provided in the side surface.

10. A carriage coupled to and pulled by the traveling device according to claim 1, the carriage comprising:
the traveling wheel;
the accommodator that accommodates the traveling device; and
a second guide roller provided on an inner surface of the accommodator, the second guide roller contactable with the traveling device.

11. The carriage according to claim 10, wherein the second guide roller is arranged at a corner of an insertion opening through which the traveling device is inserted.

12. The carriage according to claim 10, wherein the second guide roller is arranged at a height from a floor surface different from that of the first guide roller.

13. The carriage according to claim 10, wherein a side plate that contacts the first guide roller is provided at an inner surface of the accommodator.
